(19) United States
(12) Patent Application Publication
(10) Pub. No.: US 2011/0285178 A1
(43) Pub. Date: Nov. 24, 2011

(54) ACOUSTICALLY ABSORPTIVE VEHICLE HEADLINER

(76) Inventors: Chi Li, Farmington Hills, MI (US); Justin Lee Healy, Canton, MI (US); Mike James Whitens, Novi, MI (US); Jane Maria Aselage, White Lake, MI (US)

(21) Appl. No.: 12/782,865

(22) Filed: May 19, 2010

(51) Int. Cl. B60R 13/02

(52) U.S. Cl. 296/214

(57) ABSTRACT

A vehicle headliner includes an air permeable foam having open cells and a surface cover adhered to one side of the foam core. An air permeable hydrophobic layer is adhered to the opposite side of the foam core. The hydrophobic layer restricts liquid penetration and allows air permeation into the headliner for acoustic dampening.

### FIELD OF THE INVENTION

The present invention generally relates to automotive vehicle headliners, and more particularly relates to a lightweight automotive headliner that provides enhanced acoustic dampening.

### BACKGROUND OF THE INVENTION

Automotive vehicles are commonly equipped with headliners installed underneath the roof within the passenger compartment. Thermoset polyurethane headliners are generally cost-effective and lightweight. Conventional polyurethane headliner construction typically includes blocking layers that prevent liquid thermoset adhesive from bleeding through one or more surfaces or layers of the headliner. Liquid adhesive can leak into the mold during manufacture and can create an unacceptable appearance. The presence of the conventional blocking layers prevents air and other sound waves from passing into and through the headliner and prevents the sound within the interior of the vehicle passenger compartment from being adequately absorbed by the headliner.

It is therefore desirable to provide for a vehicle headliner which is lightweight, cost-effective and provides desirable acoustic dampening.

### SUMMARY OF THE INVENTION

According to one aspect of the present invention, a vehicle headliner is provided that includes an air permeable foam core, a surface cover, and an adhesive disposed on opposite sides of the foam core. The headliner also includes an air permeable hydrophobic layer that restricts liquid penetration and allows air permeation into the headliner for acoustic dampening.

According to another aspect of the present invention, a vehicle headliner is provided that includes an air permeable foam core, a first adhesive provided on a first side of the foam core, and a surface cover adhered to the first side of the foam core via the first adhesive. The headliner also includes a second adhesive disposed on a second opposite side of the foam core and an air permeable hydrophobic layer adhered to the second side of the foam core via the second adhesive. The air permeable hydrophobic layer restricts liquid penetration and allows air permeation into the headliner for acoustic dampening.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is a perspective view of a vehicle employing a thermoset polyurethane headliner, according to one embodiment;

FIG. 2 is an enlarged cross-sectional view of the headliner taken through line II-II of FIG. 1; and

FIG. 3 is an enlarged cross-sectional view taken through a thermoset polyurethane headliner, according to a second embodiment.

### DETAILED DESCRIPTION OF PREFERRED EMBODIMENTS

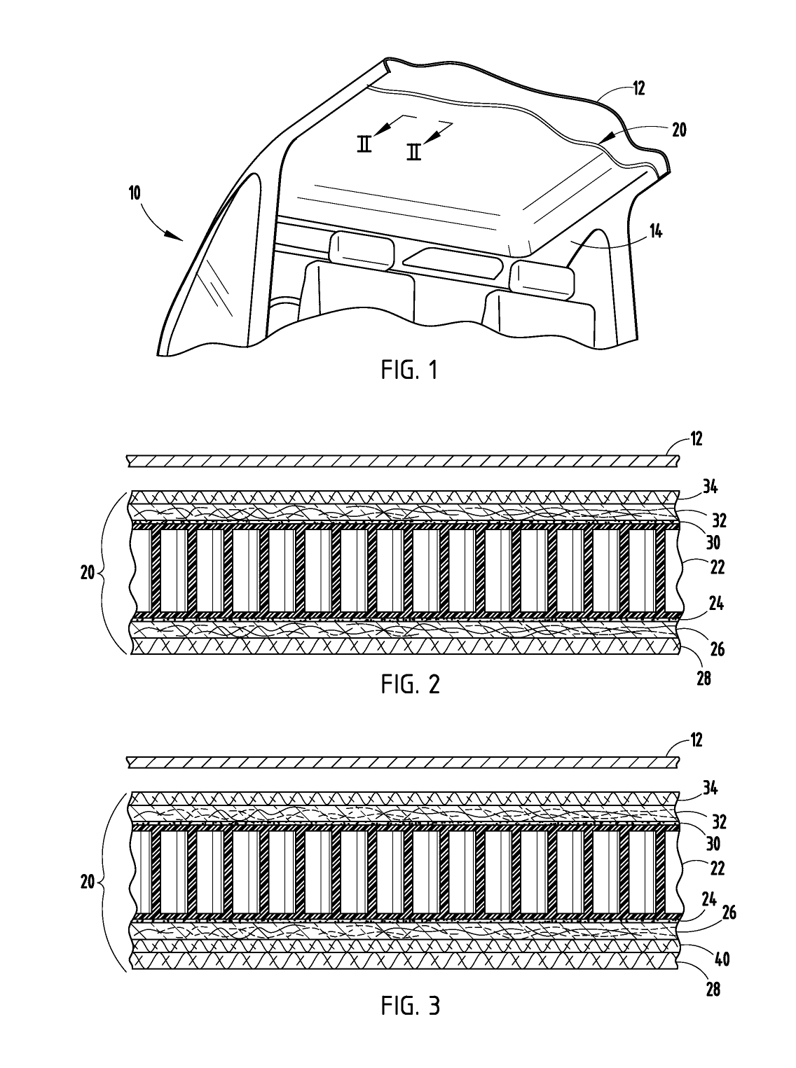

Referring now to FIG. 1, a thermoset polyurethane headliner 20 is shown attached to the underside of a roof 12 of an automotive vehicle 10, generally covering a substantial portion of the vehicle passenger compartment 14. The headliner 20 may have a conventional shape and may be installed to the underside of the vehicle roof 12 with the use of fasteners and/or adhesives as is generally known in the art. The vehicle 10 may include any passenger vehicle including, but not limited to, a car, a truck, a van, a cross-over vehicle and a bus. The headliner 20 may have various components assembled thereto including one or more overhead consoles, lights, vents and control switches. The thermoset polyurethane headliner 20 is constructed of materials that are air and sound wave permeable to allow acoustical absorption and dampening of sound in a manner that provides lightweight and high strength properties.

Referring to FIG. 2, the headliner 20 is shown spaced below the vehicle roof 12 and made up of various layers of air and sound permeable materials, according to a first embodiment. Headliner 20 includes a lightweight foam core 22 made up of a semi-rigid open cell polyurethane foam. The polyurethane foam core 22 is formed as an open cell foam that is air permeable and is permeable to sound waves such that air and sound waves pass through the foam core 22 and at least some of the acoustical sound waves get absorbed in the porous medium. The polyurethane foam core 22 may have a thickness after molding in the range of 2 to 20 millimeters according to one embodiment, and more preferably in the range of about 8 to 10 millimeters. The open cell pores may have pore size distribution in the range of 0.01 to 0.5 millimeters, according to one embodiment. The polyurethane foam core 22 may have an airflow resistivity in the range of about 200 to 700 rayls.

Bonded onto the bottom side of the foam core 22 is a first or bottom adhesive layer 24 and a chopped glass fiber mat 26. The fiberglass mat 26 may be formed with an array of chopped glass fibers that are randomly oriented with numerous spaces between fibers to allow for airflow and sound penetration. The fiberglass mat 26 provides structural rigidity to one side of the foam core 22. A fabric surface cover 28 is adhered to the bottom of the glass fibers 26 and the bottom of the foam core 22 via the adhesive layer 24. The cover 28 forms the visible bottom surface of the headliner 20 which is visible to passengers in the vehicle 10. The cover 28 may include a woven fabric, according to one embodiment. According to another embodiment, the cover 28 includes a non-woven fabric. The fabric may include a flame laminated soft foam that has an open cell polyurethane which is also permeable to air and sound waves. The cover 28 has a substantially open air porosity such that air and sound, such as noise, pass through with little resistance.

Bonded onto the top side of the foam core 22 is a second or top adhesive layer 30 and a chopped glass fiber mat 32. The fiberglass mat 32 may be formed with an array of chopped glass fibers that are randomly oriented with spaces between fibers to allow for air flow and sound penetration. The fiberglass mat 32 provides further structural rigidity to the opposite side of the foam core 22. The headliner 20 includes an air permeable and hydrophobic backing layer 34 adhered to the fiberglass mat 32 and top side of core foam 22 via the top adhesive 30. The air permeable and hydrophobic backing layer 34 may include a felt mat that is formed of non-woven polypropylene fibers that are blended on top of each other and pressed together to form a pressed mat, according to one embodiment. According to other embodiments, the hydrophobic backing layer 34 may include pure polypropylene (PP), polyethylene terephthalate (PET), or polytetrafluoroethylene (PTFE) fibers or blends of two or more of these fibers. Other hydrophobic fibers may also be used, according to further embodiments. The backing layer 34 may be a scrim construction, according to one embodiment. The backing layer 34 is air permeable and hydrophobic in that it allows air and sound waves to pass through, but blocks liquid, particularly the liquid adhesive, from leaking or bleeding through the backing layer 34 in the mold during manufacture. The backing layer 34 may have an airflow resistivity in the range of about 10 to 50 rayls before adhering to the headliner, according to one embodiment.

The various layers of the headliner 20 are formed together in a mold during manufacture. The layers of headliner 20 may be arranged one on top the other in a mold and cured. In doing so, the adhesive layers 24 and 30 are initially provided as a liquid adhesive which is cured during the molding process in the mold to form a solid adhesive that bonds the headliner layers together with the molded shape. The hydrophobic backing layer 34 advantageously prevents the liquid adhesive 30 from passing therethrough, but allows air and sound waves to permeate the hydrophobic backing layer 34.

The resulting headliner 20 advantageously allows air and sound waves to pass through the various layers and to acoustically absorb sound waves, particularly noise. Sound waves may pass from the bottom side upward through the headliner 20 as shown in FIG. 2 and out the top hydrophobic backing layer 34 and bounce off the bottom side of the vehicle roof 12 and reenter the hydrophobic backing layer 34 and pass downward. As sound waves pass through headliner 20, some sound waves are absorbed as they pass through the various layers, particularly as they pass through the open cell foam core 22. The open cell foam core 22 may cause sound waves to bounce off of and around the open cell pores such that much of the sound waves are absorbed so as to dampen the sound. The headliner 20 may be tuned to absorb those sound waves deemed to be noise by selecting foam core cell porosity and materials that absorb noise at desired frequencies.

The thermoset polyurethane headliner 20 is air and sound permeable and is absorptive and hydrophobic such that air and sound waves are able to permeate through the headliner 20 and provide sound dampening while restricting liquid transmission. The headliner 20 achieves excellent noise, vibration and harshness (NVH) performance with a structure that is lightweight and exhibits sufficient strength characteristics. According to one embodiment, the headliner 20 has an airflow resistivity in the range of 700 to 3,000 rayls, and more preferably in the range of 700 to 2,700 rayls. Airflow resistivity is indicative of how absorptive the material is and is evaluated by determining how much air can pass through the material at a given volumetric flow rate. Air resistivity may be measured according to ASTM test method C522 “Standard Test Methods for Airflow Resistance of Acoustical Materials.”

Referring to FIG. 3, a thermoset polyurethane headliner 20 is shown according to a second embodiment. The headliner 20 has the same layers as described in connection with headliner 20 of the first embodiment and, in addition, has a second permeable hydrophobic felt layer 40 disposed between the cover fabric 28 and glass fiber mat 26. The second permeable felt layer 40 is hydrophobic such that it is air permeable and allows sound waves to pass therethrough while preventing liquid from easily passing therethrough. The second permeable felt layer 40 may prevent liquid, such as the liquid adhesive 24 from leaking or bleeding into and through the cover fabric 28. In this embodiment, the cover fabric 28 may be attached to the second permeable felt layer 40 via some of the adhesive 24 that is able to forcibly leak through a partially hydrophobic felt layer 40 during the molding process, according to one embodiment. In this embodiment, the felt layer 40 partially transmits liquid in a limited quantity. According to another embodiment, an additional layer of adhesive may be applied between the hydrophobic layer 40 and cover fabric 28 to provide the adherence therebetween, but in a limited quantity so as to prevent substantially leakage through the cover fabric 28.

Accordingly, the acoustically absorptive vehicle headliner 20 provides the lightweight and strong structure that advantageously passes and dampens acoustic sound waves, such as noise, and blocks liquid transmission through the headliner 20. The block in liquid transmission prevents the liquid adhesive from leaking or bleeding through one or more layers of headliner 20 which prevents leakage of liquid adhesive in the mold and provides an enhanced appearance. The headliner 20 may be used in any of a number of vehicles to dampen acoustical sound generated within the vehicle and/or from outside the vehicle, such as wind and road noises to provide an aesthetically pleasing and quiet vehicle passenger compartment.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A vehicle headliner comprising:
an air permeable foam core;
a surface cover;
an adhesive disposed on opposite sides of the foam core; and
an air permeable hydrophobic layer that restricts liquid penetration and allows air permeation into the headliner for acoustic dampening.

2. The headliner as defined in claim 1, wherein the hydrophobic layer is adhered to the core via the adhesive.

3. The headliner as defined in claim 1, wherein the hydrophobic layer is disposed between the adhesive and the cover.

4. The headliner as defined in claim 1, wherein the hydrophobic layer comprises polypropylene.

5. The headliner as defined in claim 4, wherein the polypropylene comprises pressed fibers that form a mat.

6. The headliner as defined in claim 1, wherein the hydrophobic layer comprises polyethylene terephthalate (PET).

7. The headliner as defined in claim 1, wherein the hydrophobic layer comprises polytetrafluoroethylene (PTFE).

8. The headliner as defined in claim 1, wherein the foam core comprises an open cell foam.

9. The headliner as defined in claim 1, wherein the adhesive comprises a first adhesive on one side of the foam core adhered to the surface cover and a second adhesive on a second side of the foam core adhered to the hydrophobic layer.

10. The headliner as defined in claim 1, wherein the foam core has a thickness in range of 2 to 20 millimeters.

11. The headliner as defined in claim 10, wherein the foam core has a thickness in the range of 8 to 10 millimeters.

12. The headliner as defined in claim 1, wherein the headliner has an airflow resistivity in the range of 700 to 3,000 rayls.

13. A vehicle headliner comprising:
an air permeable foam core;
a first adhesive provided on the first side of the foam core;
a surface cover adhered to the first side of the foam core via the first adhesive;
a second adhesive disposed on a second opposite side of the foam core; and
an air permeable hydrophobic layer adhered to the second side of the foam core via the second adhesive, wherein the air permeable hydrophobic layer restricts liquid penetration and allows air permeation into the headliner for acoustic dampening.

14. The headliner as defined in claim 13, wherein the hydrophobic layer comprises polypropylene (PP).

15. The headliner as defined in claim 14, wherein the polypropylene comprises pressed fibers that form a mat.

16. The headliner as defined in claim 13, wherein the hydrophobic layer comprises polyethylene terephthalate (PET).

17. the headliner as defined in claim 13, wherein the hydrophobic layer comprises polytetrafluoroethylene (PTFE).

18. The headliner as defined in claim 13, wherein the foam core comprises an open cell foam.

19. The headliner as defined in claim 13, wherein the foam core has a thickness in the range of 2 to 20 millimeters.

20. The headliner as defined in claim 19, wherein the foam core has a thickness in the range of 8 to 10 millimeters.

21. The headliner as defined in claim 13 further comprising glass fibers disposed on at least one of the first and second sides of the foam core.

22. The headliner as defined in claim 13, wherein the headliner has an airflow resistivity in the range of 700 to 3,000 rayls.
